(19) United States
(12) Patent Application Publication
(10) Pub. No.: US 2018/0121729 A1
(43) Pub. Date: May 3, 2018

(54) SEGMENTATION-BASED DISPLAY HIGHLIGHTING SUBJECT OF INTEREST

(71) Applicant: Umbo CV Inc., San Francisco, CA (US)

(72) Inventors: Ping-Lin Chang, Taipei (TW); Chao-Yi Chen, Taipei (TW); Pai-Heng Hsiao, Taipei (TW); Hsueh-Fu Lu, Taipei (TW); Tingfan Wu, Taipei (TW)

(21) Appl. No.: 15/341,354

(22) Filed: Nov. 2, 2016

(51) Int. Cl. G06K 9/00; G06K 9/62

(52) U.S. Cl. CPC G06K 9/00718; G06K 9/6277; G06K 9/00771; G06K 9/00362

(57) ABSTRACT

Segmentation-based techniques to display video content highlighting a subject of interest are disclosed. In various embodiments, visual content data comprising a frame of video content or a single image data is received. For each of at least a subsets of pixels comprising the visual content data a probability that the pixel is associated with an object of interest is determined. A likelihood map that identifies portions of the visual content data determined to be associated with the object of interest is determined for the visual content data based at least in part on said pixel-level probabilities. A mask layer configured to be combined with the visual content data to provide a modified visual content data in which the object of interest is highlighted is generated based at least in part on the likelihood map.

### BACKGROUND OF THE INVENTION

Video and other cameras are installed in many public and private places, e.g., to provide security, monitoring, etc. and/or may otherwise be present in a location. The number of cameras has been increasing dramatically in recent years. In former times, a security guard or other personnel may have monitored in real time, e.g., on a set of display screens, the respective feed from each of a plurality of cameras. Increasingly, automated ways to monitor and otherwise consume video and/or other image data may be required.

Some cameras have network or other connections to provide feeds to a central location. Techniques based on the detection of motion in a segment of video data have been provided to identify through automated processing a subject that may be of interest. For example, bounding boxes have been used to detect an object moving through a static scene in a segment of video. However, such techniques may be imprecise, identifying a box or other area much larger than the actual subject of interest, and the inaccuracy of such techniques may increase as the speed of movement increases. Also, a non-human animal or a piece of paper or other debris blowing through a scene may be detected by such techniques, when only a human subject may be of interest.

Techniques to highlight a subject of interest in a segment of video, such as by drawing a box or other solid line around a subject of interest, have been provided, but the quality and usefulness of such highlighting have been limited by the low level of accuracy and precision with which subjects of interest have been able to be identified through the motion-based techniques mentioned above.

### BRIEF DESCRIPTION OF THE DRAWINGS

Various embodiments of the invention are disclosed in the following detailed description and the accompanying drawings.

FIG. 1 is a block diagram illustrating an embodiment of a system to process and display video.

FIG. 2 is a flow chart illustrating an embodiment of a process to identify and highlight an object of interest in video or other visual content data.

FIG. 3 is a diagram illustrating an example of generating a modified display frame based on an originally recorded frame of video in an embodiment of a segmentation-based video processing system.

FIG. 4 is a flow chart illustrating an embodiment of a process to identify an object of interest in a frame of video data.

FIG. 5 is a flow chart illustrating an embodiment of a process to generate a segmentation mask/layer.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Segmentation-based techniques to identify and/or highlight a subject of interest in a portion of video are disclosed. In various embodiments, visual content (e.g., a single image, successive frames of video, etc.) is sent to a cloud-based or other remote service. The service processes each image/frame to identify one or more subjects of interest. A mask layer to highlight the subject(s) of interest is generated and provided to a rendering site. The rendering site uses the original visual content and the mask layer to generate and display a modified visual content (e.g., modified image or video) in which the subject(s) of interest is/are highlighted. For example, a subject of interest may be highlighted by showing an outline of the subject, displaying the subject in a distinctive color or shading, selectively blurring content immediately and/or otherwise around the subject of interest, etc.

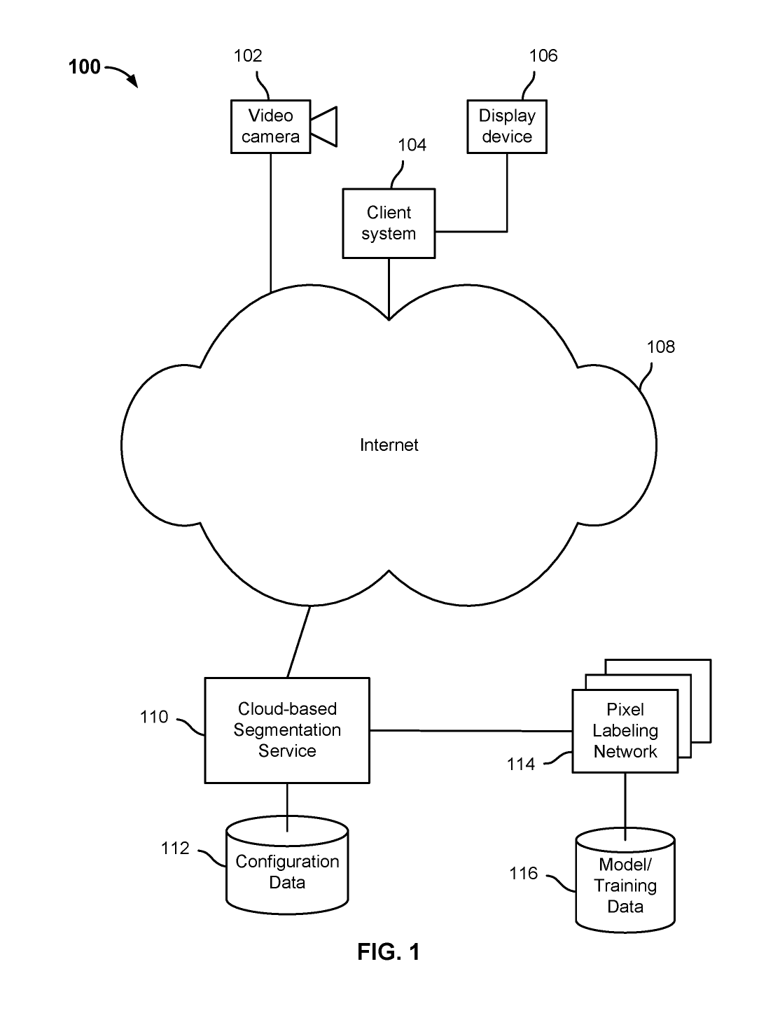

FIG. 1 is a block diagram illustrating an embodiment of a system to process and display video. In the example shown, video processing system and environment 100 includes a video camera 102 connected and an associated client system 104 connected to the Internet 108. A display device 106, such as a monitor, screen, or other display device, or a device that includes a display such as a smartphone, tablet, laptop, or other portable device, is connected to client system 104. In the example shown, the video camera 102, client system 104, and display device 106 are collocated, but in various embodiments one or more of the video camera 102, client system 104, and display device 106 may be in a remote location. While one video camera 102 is shown in FIG. 1, in various embodiments a plurality of video cameras 102 may be associated with a location and/or a client system 104. In some embodiments, client system 104 may be integrated into video camera 102. For example, video camera 102 may include one or more of a processor and a network communication interface, and may include the ability to perform the functions described herein as being performed by client system 104. In some embodiments, display device 106 may be integrated into and/or with one or both of client system 104 and video camera 102.

In various embodiments, video data generated by video camera 102 is processed internally, for example by an agent or other code running on a processor included in video camera 102, to process at least a subset of frames comprising the video content at least in part by making for each such frame a call across the Internet 108 and/or one or more other networks to a remote segmentation service 110. A copy of the video frame is cached, e.g., at video camera 102 and/or at client system 104, awaiting further processing based at least in part on a response received from the remote service with respect to the frame. Segmentation service 110 processes each frame (or single image) in a manner determined at least in part on configuration data 112. For example, configuration 112 may include for a user associated with client system 104 a configuration data indicating how video/image content associated with that user is to be processed. Examples include without limitation which types of objects are desired to be identified and highlighted in video associated with the user, a manner in which objects of interest are to be highlighted (e.g., selective blurring, etc.), etc.

In the example shown, segmentation service 110 performs segmentation, i.e., identifies objects of interest within frames of video content or other images, at least in part by calling a pixel labeling network 114. Pixel labeling network 114 may comprises a multi-layer neural network configured to relatively quickly compute for each pixel comprising a video frame a probability that the pixel is associated with an object of interest. For example, for each pixel, a probability that the pixel displays a part of a human body may be computed. In various embodiments, training data 116 may be used to train the neural network 114 to determine accurately and quickly a probability that a pixel is associated with an object of interest.

In various embodiments, probabilities received by segmentation service 110 from the pixel labeling network 114 may be used to determine for a frame of video content (or other image) a likelihood map indicating the coordinates within the video frame (or other image) that have been determined based on the pixel-level probabilities to be likely to be associated with an object of interest, such as a person or a portion thereof. The likelihood map is used in various embodiments to generate and return to client system 104 a mask layer to be combined with or otherwise applied to the original frame to generate a modified frame in which the detected object(s) of interest is/are highlighted. In some embodiments, the likelihood map is returned to client system 104 and client code running on client system 104 generates the mask layer.

In various embodiments, a sequence of video frames to which associated mask layers have been applied may be rendered via display device 106 to provide a display video in which the object(s) of interest is/are highlighted, e.g., as they move (or not) through a scene. In various embodiments, the background/scene may be static (e.g., stationary video camera) or dynamic (e.g., panning video camera). Whether the object of interest (e.g., person) moves through successive frames or not, in various embodiments techniques disclosed herein enable an object of interest to be identified in successive frames and highlighted as configured and/or desired.

While some examples described herein involve successive frames of video content, in various embodiments techniques disclosed herein may be applied to images not comprising video content, such as a digital photo or other non-video image. The term “visual content data” is used herein to refer to both video content, e.g., comprising a sequence of frames each comprising a single image, as well as single, static images.

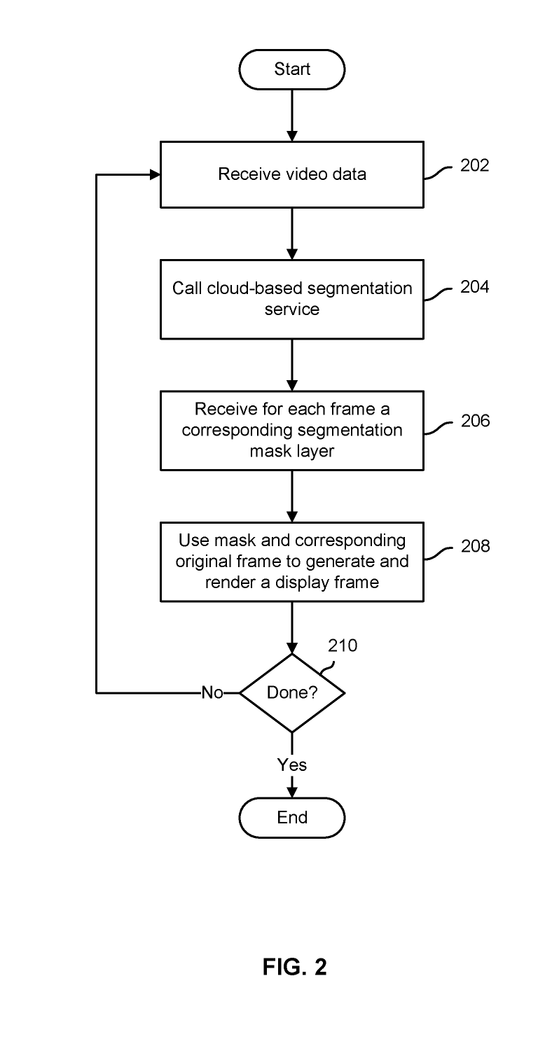

FIG. 2 is a flow chart illustrating an embodiment of a process to identify and highlight an object of interest in video or other visual content data. In various embodiments, the process of FIG. 2 may be implemented by a client system, such as client system 104 of FIG. 1. In the example shown, video data is receive (202), e.g., from a video camera such as video camera 102 of FIG. 1. A cloud-based segmentation service is called (204). For example, a frame of video data and/or a compressed or encoded representation thereof may be sent to the cloud-based segmentation service, e.g., via a network call. For each frame, a corresponding segmentation mask/layer is received from the remote segmentation service (206). The segmentation mask/layer is used along with the corresponding original frame to generate and render a displayed frame in which one or more objects of interest are highlighted (208). Successive frames may be processed in the same manner as described above until a set of video content data has been processed (210), after which the process ends.

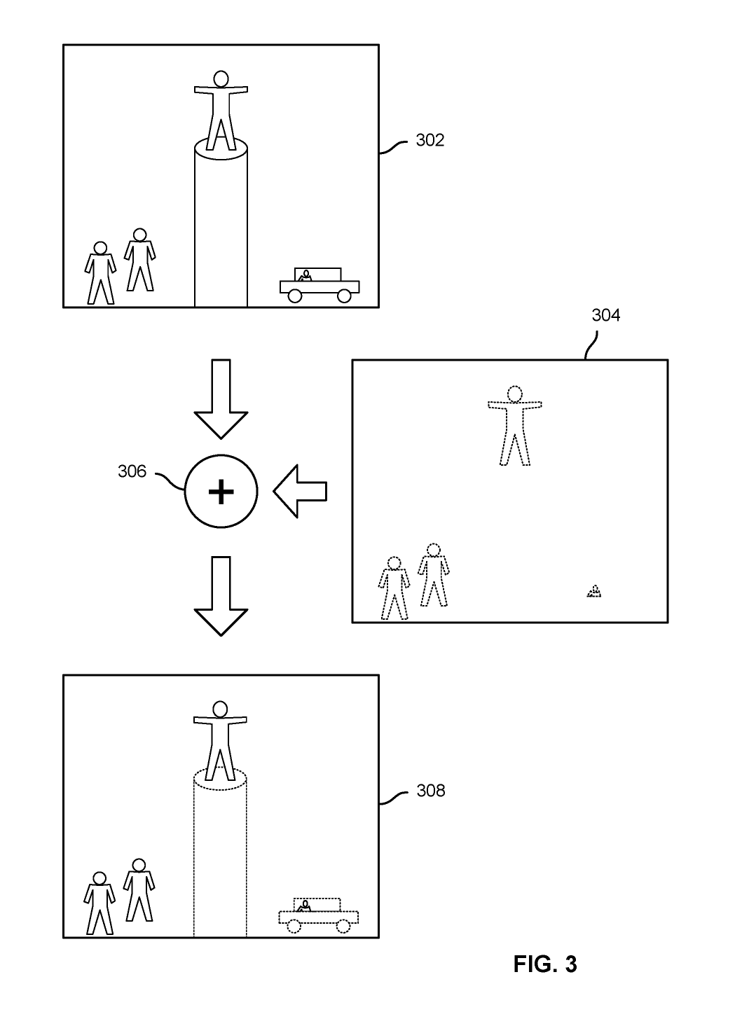

FIG. 3 is a diagram illustrating an example of generating a modified display frame based on an originally recorded frame of video in an embodiment of a segmentation-based video processing system. In various embodiments, the processing illustrated by the example shown in FIG. 3 may be performed by a client system, such as client system 104 of FIG. 1, and/or may be achieved at least in part by performing the process of FIG. 2. In the example shown, an originally recorded frame of video content 302 depicts a scene in which two pedestrians are shown at the lower left, an inanimate human figure (e.g. a statue) standing atop a pedestal is shown at center, and a person driving through the scene at some distance is shown in the lower right quadrant.

In the example shown, a segmentation mask layer 304 has been received in which data identifying four objects of interest and for each a corresponding outline/extent is embodied. In the example shown, the four subjects having human form have been identified. Note that the statue has been identified as human even though it is inanimate. Also, differences in size/scale and differences in the speed at which objects of interest may be moving through the depicted scene have not affected the fidelity with which human figures have been identified. The original video frame 302 and the segmentation mask layer 304 are combined by a process or module 306 to produce a modified display frame 308. In this example, in the combined display frame 308 the objects of interest are shown in their original form and regions around them have been selectively blurred, as indicated by the dashed lines used to show non-human objects such as the pedestal and the car.

In various embodiments, successive modified display frames, such as display frame 308, may be generated and displayed in sequence to provide a modified moving video content in which objects of interest are highlighted as disclosed herein, e.g., while such objects of interest move through a video scene depicting a real world location or set of locations.

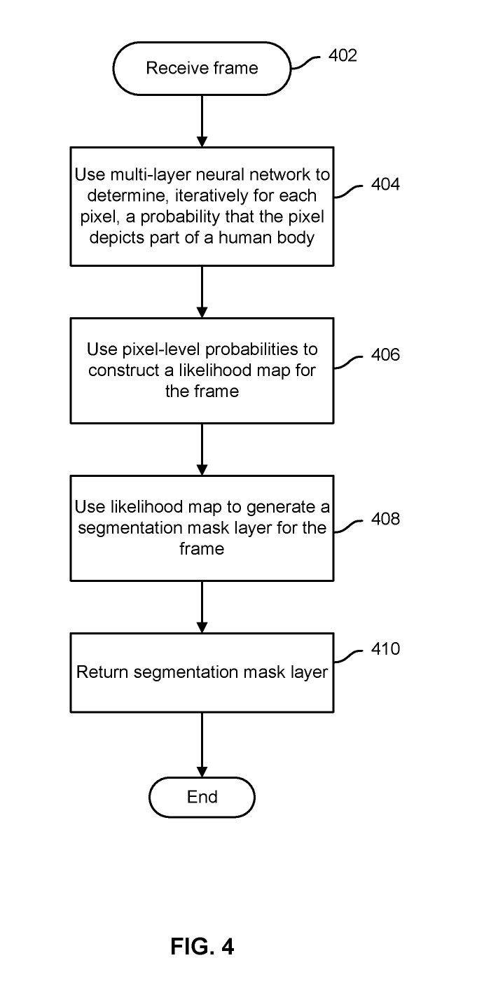

FIG. 4 is a flow chart illustrating an embodiment of a process to identify an object of interest in a frame of video data. In various embodiments, the process of FIG. 4 may be implemented by a cloud-based or other video segmentation service, such as segmentation service 110 of FIG. 1. In the example shown, for each frame that is received (402) a multi-layer neural network, such as pixel labeling network 114 of FIG. 1, is invoked to determine, iteratively for each pixel comprising the frame, a probability that the pixel depicts a part of a human body (or some other object of interest) (404). The pixel-level probabilities are used to construct a likelihood map for the frame (406). In various embodiments, the likelihood map embodies and/or encodes information indicating coordinates (e.g., outlines) for objects of interest depicted in the frame, such as human figures or portions thereof. The likelihood map is used to generate a segmentation mask/layer for the frame (408). The segmentation mask/layer is constructed so that when combined with the original data frame, e.g., at a remote client system that called the segmentation service, the resulting display frame highlights the object(s) of interest, such as by selectively blurring portions of the frame that do not include the object(s) of interest. The segmentation mask/layer is returned (410), e.g., to the node that called the service.

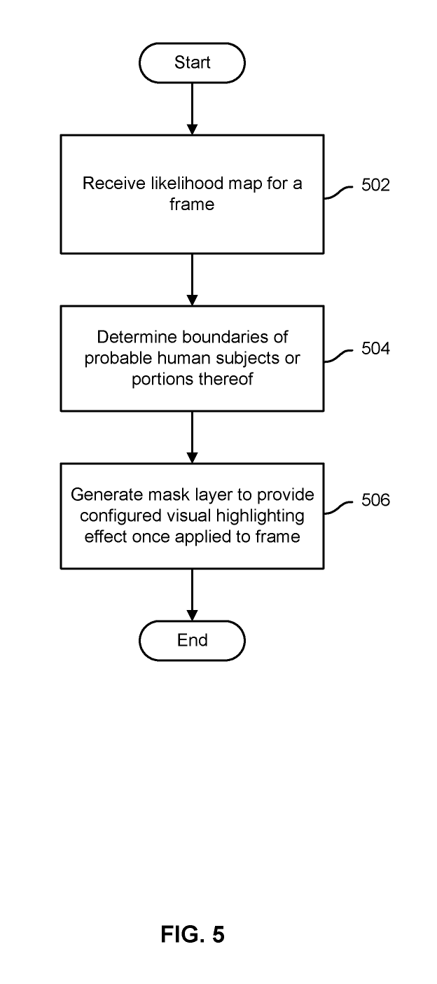

FIG. 5 is a flow chart illustrating an embodiment of a process to generate a segmentation mask/layer. In various embodiments, the process of FIG. 5 may be performed to implement step 408 of the process of FIG. 4. In the example shown, a likelihood map associated with a frame of video content data is received (502). Boundaries (outlines) for human or other objects of interest in the frame are determined based at least in part on the likelihood map (504). A mask/layer reflecting and embodying the determined boundaries, and which is configured to cause the associated objects to be displayed in a highlighted manner in a modified frame generated by combining the mask/layer with and/or otherwise applying it to the original frame, is generated (506).

In various embodiments, a cloud-based segmentation service as disclosed herein may be called and may return a mask layer that identifies portions of a frame of video or other image as being associated with an object of interest. In some embodiments, a local process (e.g., camera 102 and/or client 104 of FIG. 1) may be configured to determine based at least in part on the mask layer that an alert or other notification is to be generated. In some embodiments, the alert or other notification may be generated based at least in part on a determination that the portion of a video frame or other image that has been determined to be associated with an object of interest, such as a person/body part, is located within the frame or image at a location that is a protected or monitored location, such as a portion within a fence or other secure perimeter, and/or otherwise associated with a protected resource. The combination of the object of interest being detected and its location being a location associated with a protect resource may trigger the responsive action in various embodiments.

In various embodiments, techniques disclosed herein may be used to identify an object of interest in visual content data quickly and to generate and render modified visual content data in which such objects are highlighted in a desired manner.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
a memory or other data storage device configured to store a visual content data comprising a frame of video content or a single image data; and
a processor coupled to the memory or other data storage device and configured to:
determine for each of at least a subsets of pixels comprising the visual content data a probability that the pixel is associated with an object of interest;
determine for the visual content data based at least in part on said pixel-level probabilities a likelihood map that identifies portions of the visual content data determined to be associated with the object of interest; and
generate based at least in part on the likelihood map a mask layer configured to be combined with the visual content data to provide a modified visual content data in which the object of interest is highlighted.

2. The system of claim 1, wherein said pixel-level probabilities are determined at least in part by invoking a multi-layer neural network comprising a pixel labeling network.

3. The system of claim 1, wherein said visual content data is associated with a request received from a remote client system with which the visual content data is associated.

4. The system of claim 3, wherein said client system is configured to receive said mask layer in response to said request and to combine the mask layer with the visual content data at the client system to generate and display said modified visual content data.

5. The system of claim 1, wherein said object of interest is highlighted in said modified frame at least in part by displaying one or both of an outline of the object of interest and a translucent colored overlay displayed over the object of interest.

6. The system of claim 1, wherein said object of interest is highlighted in said modified frame at least in part by selectively blurring portions of the frame that are not associated with the object of interest.

7. The system of claim 1, wherein the object of interest comprises a human body or part thereof and said probability that a given pixel is associated with the object of interest comprises a probability that the given pixel depicts at least in part a human body part.

8. The system of claim 1, wherein said object of interest is not detected based on motion within a sequence of frames of video with which the visual content data is associated.

9. The system of claim 1, wherein the processor is further configured to generate a responsive action based at least in part on said determination that portions of the visual content data are associated with the object of interest.

10. The system of claim 9, wherein the responsive action comprises sending an alarm or other notification.

11. The system of claim 9, wherein the processor is further configured to generate a responsive action based at least in part on a determination that said portions of the visual content data that have been determined to be associated with the object of interest are associated with a protected resource of interest.

12. A method, comprising:
receiving a visual content data comprising a frame of video content or a single image data;
determining for each of at least a subsets of pixels comprising the visual content data a probability that the pixel is associated with an object of interest;
determining for the visual content data based at least in part on said pixel-level probabilities a likelihood map that identifies portions of the visual content data determined to be associated with the object of interest; and
generating based at least in part on the likelihood map a mask layer configured to be combined with the visual content data to provide a modified visual content data in which the object of interest is highlighted.

13. The method of claim 12, wherein said pixel-level probabilities are determined at least in part by invoking a multi-layer neural network comprising a pixel labeling network.

14. The method of claim 12, wherein said visual content data is associated with a request received from a remote client system with which the visual content data is associated.

15. The method of claim 14, wherein said client system is configured to receive said mask layer in response to said request and to combine the mask layer with the visual content data at the client system to generate and display said modified visual content data.

16. The method of claim 12, wherein said object of interest is highlighted in said modified frame at least in part by displaying one or both of an outline of the object of interest and a translucent colored overlay displayed over the object of interest.

17. The method of claim 12, wherein said object of interest is highlighted in said modified frame at least in part by selectively blurring portions of the frame that are not associated with the object of interest.

18. The method of claim 12, wherein the object of interest comprises a human body or part thereof and said probability that a given pixel is associated with the object of interest comprises a probability that the given pixel depicts at least in part a human body part.

19. The method of claim 12, wherein said object of interest is not detected based on motion within a sequence of frames of video with which the visual content data is associated.

20. A computer program product embodied in a non-transitory computer readable medium and comprising computer instructions for:
receiving a visual content data comprising a frame of video content or a single image data;
determining for each of at least a subsets of pixels comprising the visual content data a probability that the pixel is associated with an object of interest;
determining for the visual content data based at least in part on said pixel-level probabilities a likelihood map that identifies portions of the visual content data determined to be associated with the object of interest; and
generating based at least in part on the likelihood map a mask layer configured to be combined with the visual content data to provide a modified visual content data in which the object of interest is highlighted.
